(19) United States
(12) Patent Application Publication
(10) Pub. No.: US 2024/0241781 A1
(43) Pub. Date: Jul. 18, 2024

(54) DEVICE CONTROL METHOD AND APPARATUS, ELECTRONIC DEVICE AND READABLE STORAGE MEDIUM

(71) Applicant: Luxshare Precision Industry Company Limited, SHENZHEN (CN)

(72) Inventor: SHIH-WEI WAN, SHENZHEN (CN)

(73) Assignee: Luxshare Precision Industry Company Limited, SHENZHEN (CN)

(21) Appl. No.: 18/387,941

(22) Filed: Nov. 8, 2023

(30) Foreign Application Priority Data
Nov. 8, 2022 (CN) 202211395045.4

(51) Int. Cl. G06F 11/07; G06V 10/75

(52) U.S. Cl. CPC G06F 11/079; G06V 10/751

(57) ABSTRACT

Disclosed are a device control method and apparatus, an electronic device and a readable storage medium. The device control method includes steps: acquiring real-time picture data, and identifying the real-time picture data to obtain device information of a to-be-controlled device in the real-time picture data; displaying a control module corresponding to the device information; and receiving a setting instruction triggered based on the control module, and sending a control signal corresponding to the setting instruction to the to-be-controlled device.

### CROSS-REFERENCE TO RELATED APPLICATION

The present disclosure claims all rights and interests to Utility Patent Application No. 202211395045.4, entitled “Device Control Method and Apparatus, Electronic Device and Readable Storage Medium”, filed to the China National Intellectual Property Administration on Nov. 8, 2022, the entire content of which is incorporated herein by reference.

### TECHNICAL FIELD

The present disclosure generally relates to the field of device control, in particular to a device control method and apparatus, an electronic device and a readable storage medium.

### BACKGROUND

In the related art, identifiers, such as QR codes, are mostly set on devices. When a user needs to control a device, the user scans a QR code to convert to a corresponding control interface, and controls the device based on the control interface. However, this kind of control mode needs to scan the QR code at a close range, the user cannot control the device when being located on a side where the device is not provided with the QR code, and meanwhile, when a plurality of devices need to be controlled, the QR codes on the devices need to be scanned in sequence, which is inconvenient for the user to use.

### SUMMARY

The present disclosure provides a device control method and apparatus, an electronic device and a readable storage medium, which are intended to solve the technical problem of control modes of devices are not convenient and fast enough in the related art.

In order to solve the above technical problem or at least partly solve the above technical problem, the present disclosure provides a device control method, including steps:
acquiring real-time picture data, and identifying the real-time picture data to obtain device information of a to-be-controlled device in the real-time picture data;
displaying a control module corresponding to the device information; and
receiving a setting instruction triggered based on the control module, and sending a control signal corresponding to the setting instruction to the-to-be-controlled device.

In some embodiments, the control module includes at least one control unit; and the step of displaying the control module corresponding to the device information includes:
acquiring controllable item information in the device information;
generating a control key corresponding to the controllable item information; and
displaying the control unit containing the controllable item information and the control key in the real-time picture data.

In some embodiments, the step of displaying the control module corresponding to the device information includes:
judging whether a plurality of to-be-controlled devices are provided;
acquiring a displaying position associated with each to-be-controlled device in a case that a plurality of to-be-controlled devices are provided; and
displaying the control module of the associated to-be-controlled device in each displaying position respectively.

In some embodiments, the step of identifying the real-time picture data to obtain the device information of the to-be-controlled device in the real-time picture data includes:
identifying the real-time picture data to obtain feature information of a to-be-identified device in the real-time picture data;
matching the to-be-controlled device corresponding to the feature information among connected devices; and
acquiring device information of the to-be-controlled device.

In some embodiments, after the step of obtaining the device information of the to-be-controlled device in the real-time picture data, the method includes:
acquiring connection signal strength in the device information;
judging whether the connection signal strength is less than a preset strength threshold corresponding to the to-be-controlled device; and
displaying preset warning information in a case that the connection signal strength is less than the preset strength threshold corresponding to the to-be-controlled device.

In some embodiments, after the step of obtaining the device information of the to-be-controlled device in the real-time picture data, the method includes:
acquiring basic device information in the device information; and
displaying the basic device information.

In some embodiments, after the step of obtaining the device information of the to-be-controlled device in the real-time picture data, the method includes:
judging whether the to-be-controlled device is faulty according to the device information;
acquiring fault information in a case that the to-be-controlled device is faulty, and acquiring preset processing information corresponding to the fault information; and
displaying the fault information and the preset processing information.

In order to achieve the above objective, the present disclosure further provides a device control apparatus, including:
a first acquiring module, configured to acquire real-time picture data, and identify the real-time picture data to obtain device information of a to-be-controlled device in the real-time picture data;
a first displaying module, configured to display a control module corresponding to the device information; and
a first receiving module, configured to receive a setting instruction trigged based on the control module, and send a control signal corresponding to the setting instruction to the to-be-controlled device.

In order to achieve the above objective, the present disclosure further provides an electronic device, the electronic device includes a memory, a processor and a computer program stored on the memory and capable of operating on the processor, and the computer program, when executed by the processor, implements steps of the device control method of the present disclosure.

In order to achieve the above objective, the present disclosure further provides a computer readable storage medium, storing a computer program, wherein the computer program, when executed by a processor, implements steps of the device control method of the present disclosure.

### BRIEF DESCRIPTION OF FIGURES

Accompanying drawings herein are incorporated into the specification and constitute into a part of the specification, show examples consistent with the present disclosure, and are used to explain principles of the present disclosure with the specification.

In order to illustrate technical solutions of the examples of the present disclosure more clearly, the accompanying drawings required to be used in the examples are simply introduced below, and apparently, those ordinarily skilled in the art may further acquire other accompanying drawings according to these accompanying drawings without creative labor.

FIG. 1 is a schematic flow diagram of a first example of a device control method of an example of the present disclosure.

FIG. 2 is a detailed flow diagram of step S20 of a second example of a device control method of an example of the present disclosure.

FIG. 3 is a schematic structural diagram of modules of an electronic device of an example of the present disclosure.

### DETAILED DESCRIPTION

It should be understood that specific examples described herein are merely used to explain the present disclosure, and are not used to limit the present disclosure. In order to make those skilled in the art understand solutions of the present disclosure better, the technical solutions in the examples of the present disclosure are described clearly and completely in conjunction with the accompanying drawings in the present disclosure, and apparently, the described examples are merely a part of examples of the present disclosure, not all the examples. Based on the examples of the present disclosure, all other accompanying drawings acquired by those ordinarily skilled in the art without creative labor all belong to the scope of protection of the present disclosure.

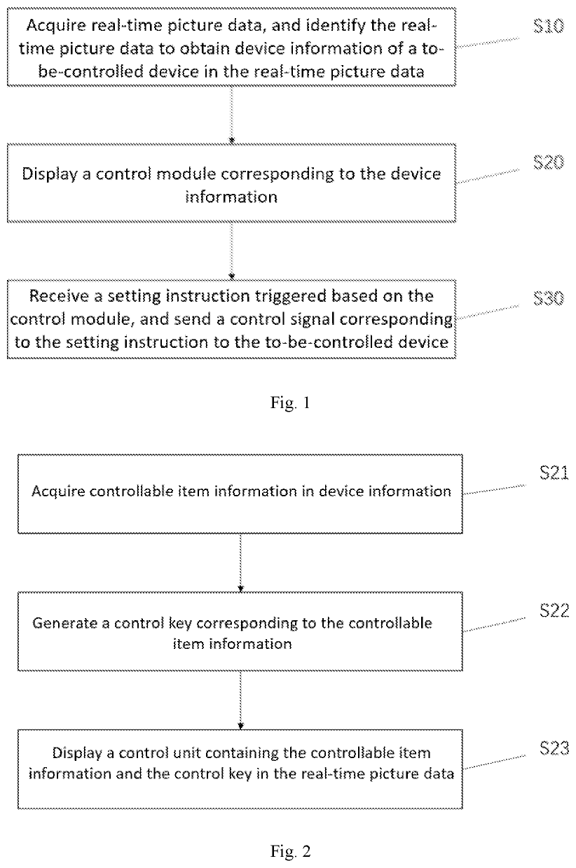

The present disclosure provides a device control method, applied to a device control apparatus, and the device control apparatus may be a cell phone, a tablet computer and other smart terminals. Referring to FIG. 1, FIG. 1 is a schematic flow diagram of a first example of a device control method of the present disclosure. This embodiment and subsequent embodiments take the device control apparatus as a cell phone to illustrate, and other types of device control apparatuses may be executed analogically, which is not repeated. The device control method includes steps:
step S10, real-time picture data is acquired and identified to obtain device information of a to-be-controlled device in the real-time picture data;
step S20, a control module corresponding to the device information is displayed; and
step S30, a setting instruction trigged based on the control module is received, and a control signal corresponding to the setting instruction is sent to the to-be-controlled device.

The real-time picture data may be a picture or a video. In some embodiments, the real-time picture data may be collected through a picture acquisition apparatus such as a camera, a specific identification method for the real-time picture data may be selected based on practical application scenarios and needs, such as a neural network, and a specific neural network training mode may be selected based on practical application scenarios and needs as well, such as Google TensorFlow, you only look once (YOLO), etc. The to-be-controlled device refers to a controllable device contained in a real-time picture. The device information is used for representing features of the to-be-controlled device. The device information includes but is not limited to types, models, and names of target devices.

The type of the to-be-controlled device may be determined through the device information, different to-be-controlled devices correspond to different control operations, therefore, different to-be-controlled devices correspond to different control modules, and after the device information is obtained, the type of the to-be-controlled device is determined according to the device information, and the control module corresponding to the to-be-controlled device is matched.

It needs to be noted that when the control module is displayed, displaying of the real-time picture data may be maintained, at the same time, the control module is displayed in the real-time picture data, and in this case, the control module may be displayed through, but not limited to, a pop-up window, an AR and other modes; and displaying of the real-time picture data may further be finished, and the control module is displayed in a generated control page.

A user may trigger a setting instruction corresponding to a control item by selecting a corresponding control item in the control module, and after receiving the setting instruction, a control signal corresponding to the setting instruction is matched and sent to the to-be-controlled device. It needs to be noted that different to-be-controlled devices correspond to different control signals; for example, for the to-be-controlled device being a smart device with a wireless connection, a cell phone is connected with a smart home device through Bluetooth or WiFi and other wireless connection modes in advance, and when the control signal needs to be sent, the control signal is sent through the corresponding wireless connection mode; for another example, the to-be-controlled device is a smart device without a wireless connection, a cell phone may be associated with a smart device at a server side, and when the control signal needs to be sent, the control signal is sent to the server side, and then is sent to the associated smart device through the server side; and for another example, the to-be-controlled device is a non-smart device, when the control signal needs to be sent, a control signal corresponding to the non-smart device may be generated, such as an infrared signal, and the infrared signal is directly used as the control signal to be sent to the to-be-controlled device. It needs to be noted that a plurality of control instruction sets may be preset in the to-be-controlled device, and the to-be-controlled device determines an instruction set corresponding to the control signal from the plurality of control instruction sets based on the control signal, and then a specific operation is implemented based on the control instruction contained in the instruction set; and the control signal containing the control instruction may further be directly sent to the to-be-controlled device at a cell phone side, and the to-be-controlled device executes a corresponding operation according to the control instruction in the control signal.

This example identifies the real-time picture data, so that the device information of the to-be-controlled device may be determined by catching the to-be-controlled device through the real-time picture data, which will not be limited by an orientation of the device, it is convenient for the user to control the to-be-controlled device, the plurality of to-be-controlled devices in the plurality of pieces of real-time picture data may further be controlled at the same time, and the control efficiency is improved.

In some embodiments, referring to FIG. 2, in a second example of the device control method of the present disclosure proposed based on the first example of the present disclosure, the control module includes at least one control unit; and step S20 includes steps:
step S21, controllable item information in the device information is acquired;
step S22, a control key corresponding to the controllable item information is generated; and
step S23, the control unit containing the controllable item information and the control key is displayed in the real-time picture data.

The controllable item information is used for indicating operating parameters of the to-be-controlled device allowing to be controlled; it may be understood that different to-be-controlled devices correspond to different controllable item information; for example, when the to-be-controlled device is an air conditioner, the controllable item information includes temperature rise, temperature reduction, wind directions, pattern, etc.; when the to-be-controlled device is a smart table, the controllable item information includes ascending, descending, etc.; when the to-be-controlled device is a stereo, the controllable item information includes volume+, volume−, play, pause, etc.; and when the to-be-controlled device is a video camera, the controllable item information includes speed, playback, pause, etc.

After the controllable item information of the to-be-controlled device is determined, the corresponding control key is generated based on the controllable item information, it needs to be explained that when there are too many controllable items contained in the controllable item information, a basic controllable item may be set, when the control key needs to be generated, a control key corresponding to the basic controllable item is only generated, an expanded key is generated at the same time, and when the user triggers the expanded key, control keys corresponding to other controllable items except the basic controllable item are generated and subsequently displayed.

The control unit is used for indicating the controllable information and the control key corresponding to the related controllable items. In order to make the user understand the action of the control key more clearly, the corresponding controllable information is displayed while the control key is displayed. For example, when the to-be-controlled device is an air conditioner, the control key includes temperature rise and temperature reduction, at the moment, the control unit includes a temperature rise control key and a temperature reduction control key, and includes the controllable information of temperature at the same time, and at the moment, the user can make clear that the temperature rise control key and the temperature reduction control key are used for controlling an operating parameter of temperature.

In this example, by displaying the controllable item information and the corresponding control keys in the control unit, the user can make clear of operating parameter types corresponding to the control keys.

In some embodiments, in a third example of the device control method of the present disclosure proposed based on the first embodiment of the present disclosure, step S20 includes steps:
step S24, whether a plurality of to-be-controlled devices are provided is judged;
step S25, if the plurality of to-be-controlled devices are provided, a display position associated with each to-be-controlled device is acquired;
if a single to-be-controlled device is provided, a control module is directly displayed; and
step S26, the control module associated with the to-be-controlled device is respectively displayed in each display position.

When a plurality of to-be-controlled devices are provided, it is indicated that the user needs to control the plurality of to-be-controlled devices, and therefore, a corresponding relationship between the control modules and the to-be-controlled devices needs to be cleared, so that the user can make clear of the to-be-controlled devices controlled by the control modules.

When the real-time picture data are identified, the to-be-controlled devices in the real-time picture data are positioned, positions relative to the to-be-controlled devices in the real-time picture data may be preset as display positions associated with the to-be-controlled devices, such as, an upper part, a lower part, a left side, a right side, a middle part, etc. of the to-be-controlled devices. When the plurality of to-be-controlled devices are provided in the real-time picture data, the control module of each to-be-to-be-controlled device is displayed in the display position corresponding to each to-be-controlled device.

In order to further make clear an association relationship between the control modules and the to-be-controlled devices, the control modules and the corresponding to-be-controlled devices may be isolated from other to-be-controlled devices through modes such as frame selecting and line connecting.

It needs to be noted that when there is the single-to-be-controlled device, the control module may be displayed in the display position associated with the to-be-controlled device as well, and at the same time, since there is no confusion of the control module at this moment, the control module may also be displayed in any position of the real-time picture data.

In this example, by displaying the corresponding control modules at the display positions associated with the to-be-controlled devices, the user can make clear the association relationship between the to-be-controlled devices and the control modules, avoiding different to-be-controlled devices and the control modules.

In some embodiments, in a fourth example of the device control method of the present disclosure proposed based on the first embodiment of the present disclosure, step S10 includes steps:
step S11, real-time picture data is identified to obtain feature information of to-be-identified devices in the real-time picture data;
step S12, a to-be-controlled device corresponding to the feature information is matched among connected devices; and
step S13, device information of the to-be-controlled device is acquired.

The feature information is used for representing features of the to-be-controlled device, and the feature information of the device includes, but is not limited to the type, model, brand name, name, color and SSID of the to-be-identified device. After a cell phone is connected to the device, related information of the device is acquired and stored, after the feature information is acquired, the device with the related information corresponding to the feature information is matched among the connected devices, the device is used as the to-be-controlled device, and meanwhile, device information of the to-be-controlled device is acquired.

In this example, the to-be-controlled device is determined through the feature information obtained through identification, and the device information of the to-be-controlled device can be accurately acquired.

In some embodiments, in a fifth example of the device control method of the present disclosure proposed based on the first embodiment of the present disclosure, after step S10, the method includes steps:
step S40, a connection signal strength in the device information is acquired;
step S50, whether the connection signal strength is less than a preset strength threshold corresponding to the to-be-controlled device is judged; and
step S60, if the connection signal strength is less than the preset strength threshold corresponding to the to-be-controlled device, preset warning information is displayed.

If the connection signal strength is greater than or equal to the preset strength threshold corresponding to the to-be-controlled device, an extra action is not executed.

Since the cell phone is connected with the to-be-controlled device, the connection signal strength may be determined based on connection modes, if it is a Bluetooth connection, a Bluetooth signal strength is determined, and if it is a WiFi connection, a WiFi signal strength is determined. The preset strength threshold is used for representing a signal strength capable of stably receiving a control signal; in some embodiments, the preset strength threshold may be set based on a signal receiving capability of a practical application device, it may be understood that different to-be-controlled devices have different signal receiving capabilities, and therefore, the corresponding preset strength thresholds are different; when the connection signal strength is greater than or equal to the preset strength threshold, it is considered that the to-be-controlled device can stably receive the control signal, at the moment, a subsequent operation may be executed, when the connection signal strength is less than the preset strength threshold, it is considered that the to-be-controlled device cannot stably receive the control signal, at the moment, the preset warning information is displayed, so as to indicate the user that the connection signal strength is weak; the preset warning information may be set based on actual demands, such as characters, videos, images, etc.; and in some embodiments, if it is a mode of the characters, “xxx device signal is weaker, suggesting close to or removing an interfering object” is displayed.

In this example, the receiving capability of the to-be-controlled device for the control signal can be determined through the connection signal strength, and when the connection signal strength is weaker, the user is indicated in time to adjust in time, avoiding affecting the control experience of the user.

In some embodiments, in a sixth example of the device control method of the present disclosure proposed based on the first example of the present disclosure, after step S10, the method includes steps:
step S70, basic device information in the device information is acquired; and
step S80, the basic device information is displayed.

The basic device information is used for representing basic operating information of the to-be-controlled device; and the basic device information is different based on differences of the to-be-controlled device, and may include, but is not limited to models, names, connection signal strength, electric quantity, power consumption, the number of connection lines, and connection line users. It may be understood that when the user controls the to-be-controlled device, content needs to be controlled is determined based on a real-time operation state of the to-be-controlled device, a data volume in the device information is excessively huge and cannot be completely displayed, therefore, the basic operating information is divided from the device information, and the basic operating information is displayed, so that the user can determine the real-time operation state of the to-be-controlled device based on the basic operating information.

During specific displaying, the basic device information may be displayed in the associated position of the to-be-controlled device.

In this example, by displaying the basic device information, the user can make clear of the real-time operation state of the to-be-controlled device, and decide a control strategy based on the real-time operation state.

In some embodiments, in a seventh example of the device control method of the present disclosure proposed based on the first example of the present disclosure, after step S10, the method includes steps:
step S90, whether the to-be-controlled device is faulty is judged according to the device information;
step SAO, if the to-be-controlled device is faulty, fault information is acquired, and preset processing information corresponding to the fault information is acquired;
if the to-be-controlled device is not faulty, an extra operation is not executed; and
step SB0, the fault information and the preset processing information are displayed.

In practical applications, the to-be-controlled device may be faulty, and fault types include, but are not limited to a connection fault with a cell phone, a hardware fault, and a software fault. In some embodiments, judging methods for different faults may be set based on differences of the to-be-controlled devices and differences of the fault types, for example, when it is detected that the cell phone is disconnected with the to-be-controlled device, fault information related to the connection fault is displayed; and for another example, parameter features corresponding to different faults are preset, and when the related information in the device information meets the parameter feature corresponding to a certain fault, it is considered that this fault appears.

The fault information is the related information for representing fault appearing, and includes, but is not limited to fault types, fault codes, fault causes, and fault positions; the preset processing information is used for indicating processing modes of the corresponding faults; and in some embodiments, an association relationship between the fault information and the preset processing information is preset, after it is determined that the to-be-controlled device is faulty, the preset processing information corresponding to the fault information is matched, and the fault information and the preset processing information are displayed, so that the user performs troubleshooting processing on the fault information based on the preset processing information.

In this example, by determining the faults and the corresponding preset processing information, when the to-be-controlled device is faulty, the user can be guided to perform related processing operations without checking a specification or inquiring working personnel, so as to quickly and conveniently solve the faults of the to-be-controlled device.

It needs to be noted that for each aforementioned method example, for simple description, they are all expressed as a series of action combinations, however, those skilled in the art should know that the present disclosure is not limited by described action sequences, because based on the present disclosure, some steps may adopt other sequences or may be performed at the same time. Secondly, those skilled in the art should also know that the examples described in the specification all belong to preferred examples, and actions and modules involved are not necessarily necessary for the present disclosure.

Through the description of the above implementations, those skilled in the art may clearly know that according to the method of the above examples, it may be implemented by virtue of a mode of software with a necessary general-purpose hardware platform, or of course by hardware, but in many cases, the former is the better implementation. Based on this understanding, the technical solutions of the present disclosure essentially or a part that contributes to the related art may be reflected in the form of software products, the computer software products are stored in a storage medium (such as an ROM/RAM, a diskette, and an optical disk), and a plurality of instructions are included to make a terminal device (may be a cell phone, a computer, a server, or a network device, etc.) execute the methods of the examples of the present disclosure.

The present disclosure further provides a device control apparatus for implementing the above device control method, including:
a first acquiring module, configured to acquire real-time picture data, and identify the real-time picture data to obtain device information of a to-be-controlled device in the real-time picture data;
a first displaying module, configured to display a control module corresponding to the device information; and
a first receiving module, configured to receive a setting instruction trigged based on the control module, and send a control signal corresponding to the setting instruction to the to-be-controlled device.

According to the device control apparatus, by identifying the real-time picture data, the device information of the to-be-controlled device may be determined by catching the to-be-controlled device from the real-time picture data without being limited by orientations of the device, it is convenient for a user to control the to-be-controlled device, and the plurality of to-be-controlled devices in the plurality of pieces of real-time picture data may further be controlled at the same time, thereby improving the control efficiency.

It needs to be noted that the first acquiring module in this example may be configured to execute step S10 in the example of the present disclosure, the first displaying module in this example may be configured to execute step S20 in the example of the present disclosure, and the first receiving module in this example may be configured to execute step S30 in the example of the present disclosure.

In some embodiments, the control module includes at least one control unit, and the first displaying module includes:
a first acquiring unit, configured to acquire controllable item information in the device information;
a first generating unit, configured to generate a control key corresponding to the controllable item information; and
a first displaying unit, configured to display the control unit containing the controllable item information and the control key in the real-time picture data.

In some embodiments, the first display module includes:
a first judging unit, configured to judge whether a plurality of to-be-controlled devices are provided;
a second acquiring unit, configured to acquire a display position associated with each to-be-controlled device if a plurality of to-be-controlled devices are provided; and
a second displaying unit, configured to display the control module of the associated to-be-controlled device in each display position respectively.

In some embodiments, the first acquiring module includes:
a first identifying unit, configured to identify the real-time picture data to obtain feature information of the to-be-controlled device in the real-time picture data;
a first matching unit, configured to match the to-be-controlled device corresponding to the feature information among connected devices; and
a third acquiring unit, configured to acquire device information of the to-be-controlled device.

In some embodiments, the device control apparatus further includes:
a second acquiring module, configured to acquire a connection signal strength in the device information;
a first judging module, configured to judge whether the connection signal strength is less than a preset strength threshold corresponding to the to-be-controlled device; and
a second displaying module, configured to display preset warning information if the connection signal strength is less than the preset strength threshold corresponding to the to-be-controlled device.

In some embodiments, the device control apparatus further includes:
a third acquiring module, configured to acquire basic device information in the device information; and
a third displaying module, configured to display the basic device information.

In some embodiments, the device control apparatus further includes:
a second judging module, configured to judge whether the to-be-controlled device is faulty according to the device information;
a fourth acquiring module, configured to acquire fault information if the to-be-controlled device is faulty, and acquire preset processing information corresponding to the fault information; and
a fourth displaying module, configured to display the fault information and the preset processing information.

It needs to be noted herein that instances and application scenarios implemented by the above module and the corresponding step are the same, but not limited to the content disclosed in the above example. It needs to be noted that the above modules serving as a part of the apparatus can be implemented through software, can also be implemented through hardware, wherein a hardware environment includes a network environment.

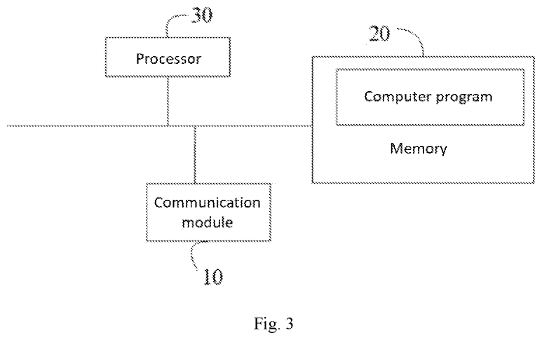

Referring to FIG. 3, on a hardware structure, an electronic device may include a communication module 10, a memory 20, a processor 30 and other components. In the electronic device, the processor 30 is respectively connected with the memory 20 and the communication module 10, the memory 20 stores a computer program, the computer program is executed by the processor 30 at the same time, and the computer program, when executed, implements the steps of the above method example.

The communication module 10 may be connected with an external communication device through a network. The communication module 10 may receive requests sent by the external communication device, may further send requests, instructions and information to the external communication device, and the external communication device may be other electronic devices, servers or devices of Internet of Things, such as a television, etc.

The memory 20 may be configured to store software programs and various data. The memory 20 may mainly include a stored program area and a stored data area, wherein the stored program area may store an operating system, at least one application program (such as acquiring real-time picture data) required by functions, etc.; and the stored data area may include a database, and may store data or information created according to use of the system. In addition, the memory 20 may include a high-speed random access memory, and may further include a nonvolatile memory, such as at least one disk storage device, a flash memory device, or other volatile solid-state memory devices.

The processor 30 is a control center of the electronic device, is connected to each part of the entire electronic device by using various interfaces and lines, and executes various functions and processing data of the electronic device by running or executing software programs and/or modules stored in the memory 20, and invoking data stored in the memory 20, so as to integrally monitor the electronic device. The processor 30 may include one or more processing units; and in some embodiments, the processor 30 may integrate an application processor and a modem processor, wherein the application processor mainly processes an operating system, a user interface, an application program and the like, and the modem processor mainly processes wireless communication. It may be understood that the above modem processor may also not be integrated into the processor 30.

Although it is not shown in FIG. 3, the above electronic device may further include a circuit control module, and the circuit control module is configured to be connected with a power supply, so as to ensure normal work of other components. Those skilled in the art may understand that the structure of the electronic device shown in FIG. 3 do not constitute a limitation to the electronic device, may include components more or less than those shown in the figure, or combine some components, or arrange different components.

The present disclosure further provides a computer readable storage medium, storing a computer program. The computer readable storage medium may be the memory 20 in the electronic device in FIG. 3, may also be at least one of a read-only memory (ROM), a random access memory (RAM), a diskette, and an optical disk, and the computer readable storage medium includes a plurality of instructions for making a terminal device (may be a television, an automobile, a cell phone, a computer, a server, a terminal, or a network device, etc.) having a processor execute the method of each example of the present disclosure.

In the present disclosure, terms “first”, “second”, “third”, “fourth” and “fifth” are only used to described the objectives, cannot be understood as indicating or implying relative importance, and those ordinarily skilled in the art may understand specific meaning of the above terms in the present disclosure according to specific conditions.

In the description of the present specification, the description of referring terms “an example”, “some examples”, “instance”, “specific instance” or “some instances” are intended to be contained in at least one example or instance of the present disclosure in conjunction with specific features, structures, materials or characteristics of the example or instance. In this specification, schematic representations of the above terms need not be directed to the same example or instance. Moreover, the described specific features, structures, materials or characteristics may be combined in any one or plurality of examples or instances in a proper mode. In addition, without contradicting each other, those skilled in the art may integrate and combine the different examples or instances described in the present specification and characteristics of different examples or instances.

Although the examples of the present disclosure have been shown and described above, the scope of protection of the present disclosure is not limited to this, it may be understood that the above examples are exemplary, and cannot be understood as a limitation to the present disclosure. Those ordinarily skilled in the art can make changes, modifications and replacements on the above examples within the scope of protection of the present disclosure, and these changes, modifications and replacements should be covered in the scope of protection of the present disclosure. Therefore, the scope of protection of the present disclosure should be subjected to the scope of protection claimed.

What is claimed is:

1. A device control method, comprising:
acquiring real-time picture data, and identifying the real-time picture data to obtain device information of a to-be-controlled device in the real-time picture data;
displaying a control module corresponding to the device information; and
receiving a setting instruction triggered based on the control module, and sending a control signal corresponding to the setting instruction to the to-be-controlled device.

2. The device control method of claim 1, wherein the control module comprises at least one control unit; and the step of displaying the control module corresponding to the device information comprises:
acquiring controllable item information in the device information;
generating a control key corresponding to the controllable item information; and
displaying the control unit containing the controllable item information and the control key in the real-time picture data.

3. The device control method of claim 1, wherein the displaying the control module corresponding to the device information comprises:
judging whether a plurality of to-be-controlled devices are provided;
acquiring a displaying position associated with each to-be-controlled device in a case that the plurality of to-be-controlled devices are provided; and
displaying the control module of the associated to-be-controlled device in each displaying position respectively.

4. The device control method of claim 1, wherein the identifying the real-time picture data to obtain the device information of the to-be-controlled device in the real-time picture data comprises:
identifying the real-time picture data to obtain feature information of a to-be-identified device in the real-time picture data;
matching the to-be-controlled device corresponding to the feature information among connected devices; and
acquiring device information of the to-be-controlled device.

5. The device control method of claim 1, after the obtaining the device information of the to-be-controlled in the real-time picture data, comprising:
acquiring a connection signal strength in the device information;
judging whether the connection signal strength is less than a preset strength threshold corresponding to the to-be-controlled device; and
displaying preset warning information in a case that the connection signal strength is less than the preset strength threshold corresponding to the to-be-controlled device.

6. The device control method of claim 1, after the obtaining the device information of the to-be-controlled device in the real-time picture data, comprising:
acquiring basic device information in the device information; and
displaying the basic device information.

7. The device control method of claim 1, after the obtaining the device information of the to-be-controlled in the real-time picture data, comprising:
judging whether the to-be-controlled device is faulty according to the device information;
acquiring fault information in a case that the to-be-controlled device is faulty, and acquiring preset processing information corresponding to the fault information; and
displaying the fault information and the preset processing information.

8. A device control apparatus, comprising:
a first acquiring module, configured to acquire real-time picture data, and identify the real-time picture data to obtain device information of a to-be-controlled device in the real-time picture data;
a first displaying module, configured to display a control module corresponding to the device information; and
a first receiving module, configured to receive a setting instruction trigged based on the control module, and send a control signal corresponding to the setting instruction to the to-be-controlled device.

9. An electronic device, comprising: a memory, a processor and a computer program stored on the memory and capable of running on the processor, wherein the computer program, when executed by the processor, implements steps of the device control method of claim 1.

10. A computer readable storage medium, storing a computer program, wherein the computer program, when executed by a processor, implements steps of the device control method of claim 1.
